(19) United States
(12) Patent Application Publication
(10) Pub. No.: US 2014/0156662 A1
(43) Pub. Date: Jun. 5, 2014

(54) PREDICTING VARIABLE IDENTIFYING DEVICE, METHOD, AND PROGRAM

(71) Applicant: Azbil Corporation, Tokyo (JP)

(72) Inventors: Tomohiro KONDA, Tokyo (JP); Chosei KASEDA, Tokyo (JP); Tasuku IMANISHI, Tokyo (JP)

(73) Assignee: AZBIL CORPORATION

(21) Appl. No.: 14/039,339

(22) Filed: Sep. 27, 2013

(30) Foreign Application Priority Data
Sep. 27, 2012 (JP) 2012-213562

(51) Int. Cl. G06F 17/30

(52) U.S. Cl. CPC G06F 17/3053
USPC 707/737

(57) ABSTRACT

A predicting variable identifying device includes a candidate profile creating portion sequentially rotates correspondence relationships between intervals in a reference profile and ranks, to create respective candidate profiles, for each different amount of rotation, a group classifying portion, based on a setting from the outside, performs classification of one interval or a plurality of continuous intervals into individual control groups, a rank match checking portion, checks, for each candidate profile B, whether or not the ranks match across the intervals that belong to identical control groups, and a predicting variable identifying portion identifies, as predicting variables, those variables that indicate energy indicator values in the intervals going back by retrospection times, from a point in time for which a prediction is to be made, for those candidate profiles wherein the ranks have been confirmed to be matching for all of the control groups.

### CROSS REFERENCE TO RELATED APPLICATION

This application claims priority under 35 U.S.C. §119 to Japanese Patent Application No. 2012-213562, filed on Sep. 27, 2012, the entire content of which being hereby incorporated herein by reference.

### FIELD OF TECHNOLOGY

The present invention relates to a data predicting technology, and, in particular, to a predicting variable identifying technology for identifying predicting variables to be used in predicting an energy indicator value used in a prediction model.

### BACKGROUND

In managing facilities such as factories and buildings, data predicting technologies are used to predict energy indicator values such as electric power or natural gas consumed by the facilities, or the amount of heat generated, amount of load heat, amount of CO₂, or the like, produced through the energy consumption by the facilities, based on a prediction model that is constructed in advance, in order to operate the various facilities systematically for the purposes of energy conservation, cost reduction, or reduction of the load on the environment.

Conventionally, a technology for predicting an air-conditioning load over an applicable predicting timeframe using a prediction model that has, as input factors, actual load data, whether data, calendar data, and schedule data regarding the ON/OFF state of the various air-conditioning equipment, has been proposed as such a data predicting technology. See, for example, Japanese Patent 4386748. Similarly, a technology for predicting future thermal loads by predicting outside temperatures and outside humidities using non-linear models from respective recently measured values, and inputting parameters related to characteristics such as floor space, walls and floors, the use of window glass, the area thereof, the amount of heat generated internally, the amount of outside air that is drawn in, the structure of the air-conditioning system, and the like has been proposed as a data predicting technology. See, for example, Japanese Patent 2874000.

However, in such a conventional data predicting technology, the object is to obtain high prediction accuracy, and thus many parameters are used, with the problem that the construction of models requires expert knowledge and a large amount of labor, such as in deciding which parameters to keep as predicting variables and which to discard, tuning the model, and the like.

In recent years, in industry, there has been a tendency to shift from conventional energy management, wherein the unit is the factory, building, or workplace, to perform instead energy management by the company as a whole, in order to comply with revisions to regulations and in order to satisfy social responsibilities in relation to the environment. In such a circumstance, there are many cases wherein the energy management is performed by not just experts, but operating staff and managers who have little experience in relation to energy management. Consequently, if such operators do not have the expert knowledge required for construction of a model, it is not possible to take full advantage of the conventional data predicting technologies described above.

Moreover, in such energy management, there are remote energy managing services as services that offer information that serves as criteria for operations. These remote management services are services that collect the rate of use of energy, such as electric power, from the various facilities of a client firm through a communication network, to predict the amount of energy used by each individual facility and the company as a whole during the prediction period, to provide the prediction results to the applicable user terminal in the company. Consequently, an operator who is involved in the energy management is able to perform energy management easily and accurately based on the prediction results that have been provided.

When a remote management service predicts the amount of energy consumption, it is necessary to structure individual prediction models in advance, due to the differences in the scope and structures of facilities from company to company, and the differences in predicting conditions, such as the operating conditions. Because of this, insofar as the prediction model is structured in advance, the data predicting technologies described above can be used to make highly accurate predictions of energy consumption.

However, in the conventional data predicting technologies described above it is necessary to collect various types of data, such as a great deal of schedule data, parameters, and the like, and to select the data to include in the data to discard, in order to reflect predicting conditions that are inherent to the facility, thus increasing the amount of labor and the amount of time that is required, driving up the costs involved in constructing the models, preventing inexpensive provision of remote management services.

The present invention is to solve such problem areas, and an aspect thereof is to provide a predicting variable identifying technology able to identify predicting variables extremely easily, without requiring the expert knowledge that is required in constructing models.

### SUMMARY

In order to solve the problem set forth above, the present invention provides a predicting variable identifying device for identifying, as a predicting variable for a prediction model that predicts an energy indicator value at a point in time that is subject to prediction, a variable indicating the energy indicator value at an interval that goes back an arbitrary retrospection time from the point in time that is subject to the prediction, from among the individual intervals that structure a period, based on periodicity of the energy indicator values that indicate the energy consumption in the facilities. The predicting variable identifying device includes a storing portion that stores a reference profile indicating a correspondence relationship between the individual intervals and ranks to which the magnitudes of the energy indicator values in the respective intervals belong, a candidate profile creating portion that sequentially rotates the correspondence relationship between the intervals and ranks in the reference profile to create, for each different amount of rotation, a respective candidate profile corresponding to the retrospection time that is the applicable amount of rotation, a control group classifying portion that classifies one interval or a plurality of continuous intervals into one control group, for each individual interval, based on a setting from the outside, a rank match checking portion that checks, for each candidate profile, whether or not the ranks match between intervals belonging to the same control groups, for the correspondence relationships between the intervals and ranks in the applicable candidate profile, and a predicting variable identifying portion that identifies, as a predicting variable for use in the prediction model, a variable that indicates the energy indicator value in the interval going back by the retrospection time corresponding to the candidate profile, from the point in time that is subject to prediction, for a candidate profile wherein the ranks have been confirmed as matching for all of the control groups.

Additionally, a predicting variable identifying method according to the present invention is used by a predicting variable identifying device for identifying, as a predicting variable for a prediction model that predicts an energy indicator value at a point in time that is subject to prediction, a variable indicating the energy indicator value at an interval that goes back an arbitrary retrospection time from the point in time that is subject to the prediction, from among the individual intervals that structure a period, based on periodicity of the energy indicator values that indicate the energy consumption in the facilities. The method includes a storing step wherein a storing portion stores a reference profile indicating a correspondence relationship between the individual intervals and ranks to which the magnitudes of the energy indicator values in the respective intervals belong, a candidate profile creating step wherein a candidate profile creating portion sequentially rotates the correspondence relationship between the intervals and ranks in the reference profile to create, for each different amount of rotation, a respective candidate profile corresponding to the retrospection time that is the applicable amount of rotation, a control group classifying step wherein a control group classifying portion classifies one interval or a plurality of continuous intervals into one control group, for each individual interval, based on a setting from the outside, a rank match checking step wherein a rank match checking portion checks, for each candidate profile, whether or not the ranks match between intervals belonging to the same control groups, for the correspondence relationships between the intervals and ranks in the applicable candidate profile, and a predicting variable identifying step wherein a predicting variable identifying portion identifies, as a predicting variable for use in the prediction model, a variable that indicates the energy indicator value in the interval going back by the retrospection time corresponding to the candidate profile, from the point in time that is subject to prediction, for a candidate profile wherein the ranks have been confirmed as matching for all of the control groups.

Furthermore, a program according to the present invention is a program that causes a computer to function as the various portions that structure the predicting variable identifying device described above. The program is embodied in a computer-readable medium.

The present invention enables the identification, as predicting variables in a prediction model, of variables able to explain both changes in an energy indicator value over individual intervals that structure a period, and the operating conditions that are inherent to the facility. Consequently, even if an operator does not have the expert knowledge required to construct a model, still predicting variables for the prediction model can be identified extremely easily. Moreover, the data required for reflecting the predicting emissions that are inherent to a facility need only be a reference profile and the result of control group classification. Because of this, the labor and time for the operation are trivial, making it possible to identify the predicting variables at an extremely low cost, making possible to provide remote management services inexpensively as well.

### BRIEF DESCRIPTION OF THE DRAWINGS

FIG. 1 is a block diagram illustrating the structure of a predicting variable identifying device.

FIG. 2 is an explanatory diagram of a facilities managing system wherein the predicting variable identifying device is used.

FIG. 3 is an example of an electric power use status displaying screen that is outputted onto a monitor of the facilities managing system.

FIG. 4 is a flowchart illustrating the predicting variable identifying procedure in the predicting variable identifying device.

FIG. 5 is a flowchart illustrating a predicting variable identifying operation in the predicting variable identifying device.

FIG. 6 is an example of a structure of a reference profile.

FIG. 7 is an explanatory diagram illustrating the method for creating a reference profile.

FIG. 8 is an example of creating a candidate profile.

FIG. 9 is an example of control group classification.

FIG. 10 is an explanatory diagram illustrating a rank match checking procedure.

FIG. 11 is specific examples of predicting variables.

### DETAILED DESCRIPTION

The principle behind the present invention will be explained first. The amount of energy consumed in a facility, such as a factory or a building, has some degree of periodicity. For example, in a factory, the operating state varies greatly depending on weekdays versus weekends, where the amount of energy consumed on weekdays is large and the amount of energy consumed on weekends is small. Moreover, in a commercial building, there tends to be an increase in the number of visitors on weekends, increasing the amount of energy consumed as well. Furthermore, in facilities managing systems, the energy indicator values for predicting do not directly control the facilities, but rather are used as values that become criteria for operational control by an operator, and thus there is no need for extremely high prediction accuracy.

The present invention focuses on the fact that such periodicity regarding the amount of energy is included also in the energy indicator values, and the fact that extremely high prediction accuracy is not required, and thus identifies, as predicting variables in a prediction model that predicts energy indicator values at specific prediction times, those variables that indicate energy indicator values that, of the various intervals that form a period, are intervals that go back by an arbitrary retrospection time from the point in time that is subject to the prediction.

On the other hand, when equipment is operating, there are times wherein there are changes to the operating status for a specific unique interval, within the period, in the given equipment. For example, in some cases, among the weekdays, there may be changes in the operating status of the equipment in the first half of the week versus the second half of the week.

The present invention focuses on such inherent operating statuses of the equipment, to identify, as predicting variables in the prediction model, those variables able to explain both the changes in the energy indicator values in the various intervals that comprise a period, and the operating statuses that are inherent to the equipment.

### EXAMPLES

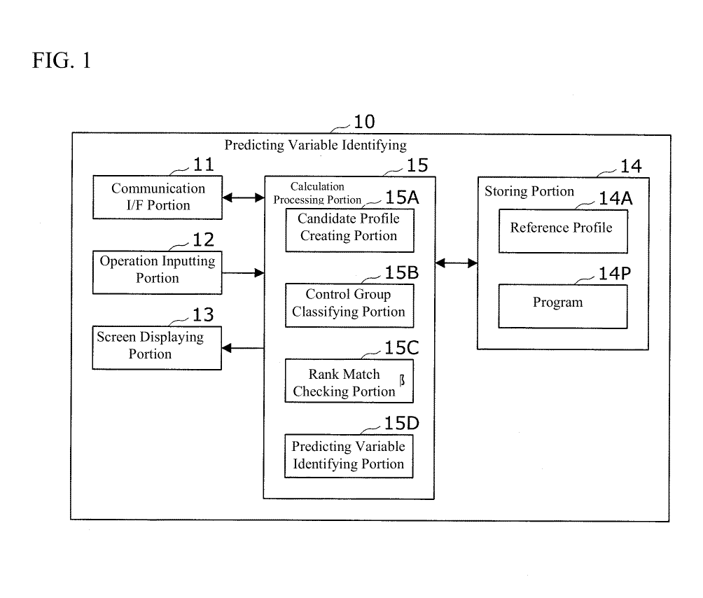

Forms for carrying out the present invention will be explained next, in reference to the figures. FIG. 1 will be referenced first to explain a predicting variable identifying device 10 according to a present example. FIG. 1 is a block diagram illustrating the structure of the predicting variable identifying device.

This prediction variable identifying device 10 overall includes an information processing device such as a server or a PC, and has the function of identifying, as predicting variables in a prediction model that predicts energy indicator values at specific prediction times, those variables that indicate energy indicator values that, of the various intervals that form a period, are intervals that go back by an arbitrary retrospection time from the point in time that is subject to the prediction.

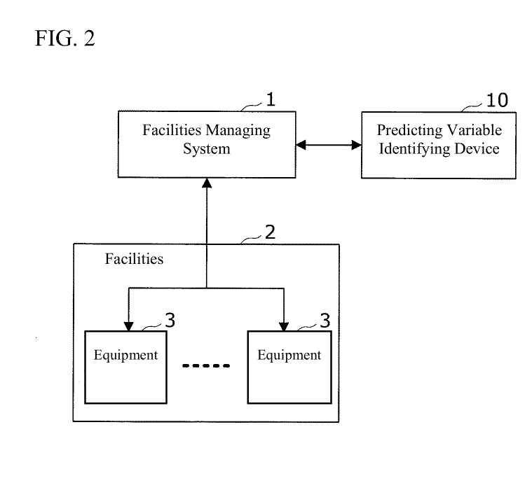

FIG. 2 is an explanatory diagram of a facilities managing system wherein the predicting variable identifying device is used. The facilities managing system 1 is a system for performing energy management regarding facilities 2, such as factories or buildings, and has a function for calculating an energy indicator value in the facilities 2 as a whole through obtaining the operating states of the various equipment 3 that are disposed in the facilities 2, and for outputting a screen to a monitor, and a function for predicting a future energy indicator value based on a prediction model that is structured in advance, to output a screen to a monitor.

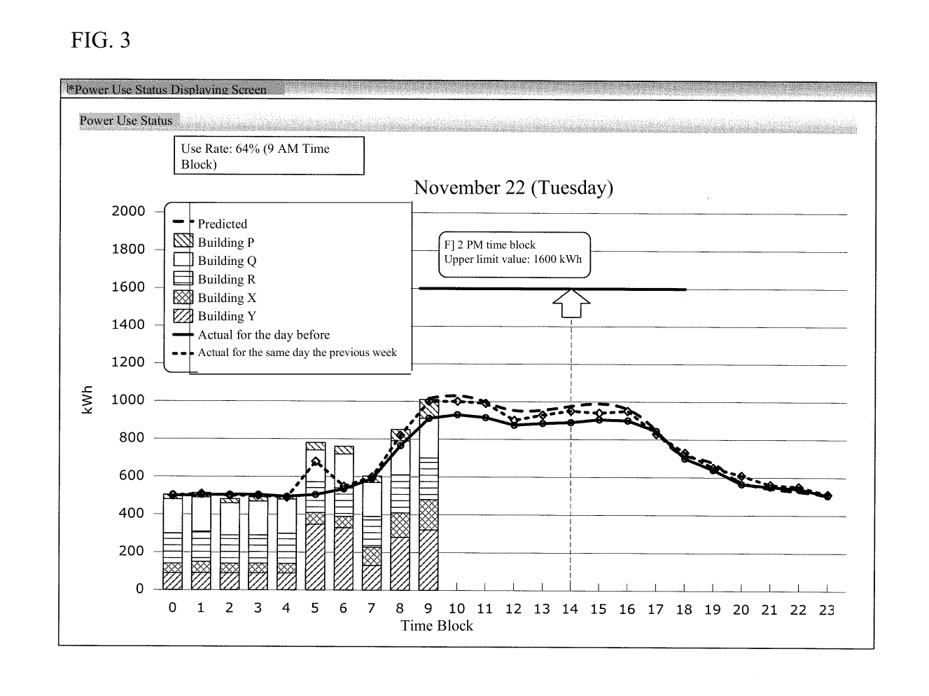

FIG. 3 is an example of an electric power use status displaying screen that is outputted onto a monitor of the facilities managing system. Here a graph is displayed showing time blocks on the horizontal axis and the amount of power used (kWh) on the vertical axis, where the amount of energy used by each building within the facilities is shown by a bar graph. Predicted values indicating the amounts of energy used in the future are displayed respectively by the line graph, along with the actual values for the amount of energy used the previous day or the same day the previous week. Moreover, an upper limit value for the amount of energy used, set in advance, and the use rate of the current amount of energy used relative to the upper limit value, are also shown.

The predicting variable identifying device 10 is connected to a facilities managing system 1 through a communication line, and outputs, to the facilities managing system 1, the predicting variable identification result that is produced. As a result, when structuring the prediction model in the facilities managing system 1, the predicting variables sent in the predicting variable identification result from the predicting variable identifying device 10 is used as one of the predicting variables in the prediction model.

### Predicting Variable Identifying Device

As the primary functional portions thereof, the predicting variable identifying device 10 is provided with a communication I/F portion 11, an operation inputting portion 12, a screen displaying portion 13, a storing portion 14, and a calculation processing portion 15.

The communication I/F portion 11 is made from a data communication circuit, and has a function for performing data communication with an external device, such as the facilities managing system 1, through a communication circuit. The operation inputting portion 12 is made from operation inputting devices such as a keyboard, a mouse, and the like, and has a function for detecting an operator operation and outputting it to the calculation processing portion 15. The screen displaying portion 13 is made from a screen displaying device such as an LCD, and has a function for displaying various types of processing screens, such as an operating menu screen, a data inputting screen, a predicting variable identification result screen, and the like, depending on an instruction from the calculation processing portion 15.

The storing portion 14 is made from a storing device, such as a hard disk or a semiconductor memory, and has a function for storing processing information or programs 14P used in processes executed by the calculation processing portion 15.

As the primary processing information stored by the storing portion 14 there is the reference profile 14A. The reference profile 14A is data indicating the correspondence with relationships between the individual intervals that comprise one period of the energy indicator values and the ranks to which the magnitudes of the energy indicator values in the respective intervals belong.

The program 14P is a program that is executed by the various types of processing portions through being executed on a CPU of the calculation processing portion 15. It is stored in advance in an external device or recording medium, and stored into the storing portion 14 through the communication I/F portion 11.

The calculation processing portion 15 includes a CPU, and has a function for embodying the various processing portions through the CPU executing the program 14P of the storing portion 14. As the main processing portions that are embodied by the calculation processing portion 15 there are the candidate profile creating portion 15A, the control group classifying portion 15B, the rank match checking portion 15C, and the predicting variable identifying portion 15D.

The candidate profile creating portion 15A has a function for reading out the reference profile 14A from the storing portion 14 and sequentially rotating the correspondence relationship between ranks and intervals in the reference profile 14A, to create respective candidate profiles, corresponding to retrospection times that are produced by the amount of rotation, for each different amount of rotation.

The control group classifying portion 15D has a function for inputting from the communication I/F portion 11 or the operation inputting portion 12, and, for each interval, performs classification of one interval or a plurality of continuous intervals into a single control group, based on settings from the outside that depend on the inherent operating statuses of the equipment, inputted through the communication I/F portion 11 or the operation inputting portion 12.

The rank match checking portion 15C has a function for checking, for each candidate profile produced by the candidate profile creating portion 15A, whether or not there are matches in ranks between the intervals belonging to identical control groups, for the correspondence relationships between the ranks and the intervals in the candidate profile.

The predicting variable identifying portion 15D has a function for identifying, as a predicting variable for use in the prediction model, a variable that, for a candidate profile confirmed by the rank match checking portion 15C, to match ranks for all of the control groups, indicates an energy indicator value in an interval that goes back, from the time that is subject to predicting, a retrospection time that corresponds to that candidate profile, a function for displaying the predicting variable identification result on the screen displaying portion 13, and a function for outputting from the communication I/F portion 11 to the facilities managing system 1.

### Operation of the Example

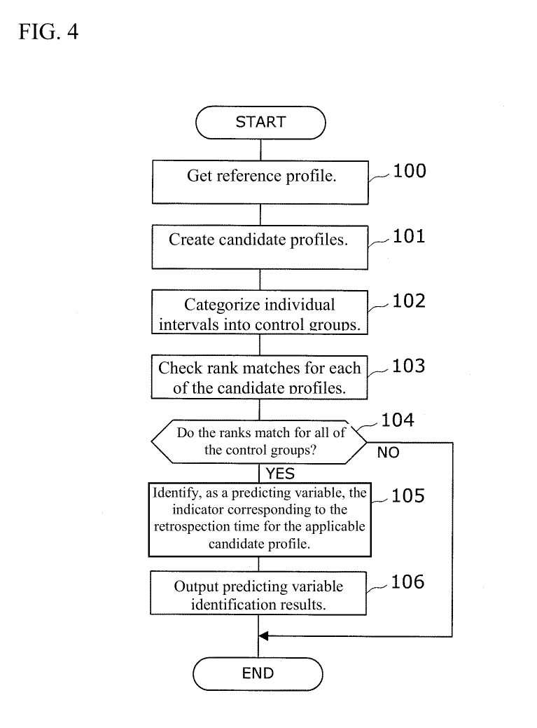

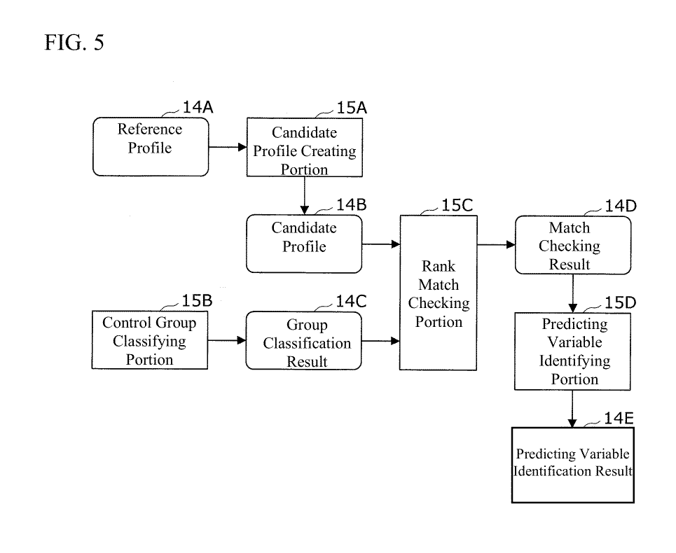

FIG. 4 and FIG. 5 will be referenced next to explain the processing operations in the predicting variable identifying device 10 according to the present example. FIG. 4 is a flowchart illustrating the predicting variable identifying procedure in the predicting variable identifying device. FIG. 5 is a flowchart illustrating a predicting variable identifying operation in the predicting variable identifying device.

The calculation processing portion 15 of the predicting variable identifying device 10 performs the predicting variable identifying procedure of FIG. 4 in response to an instruction inputted from the communication I/F portion 11 or the operation inputting portion 12. Here the explanation will use, as an example, a case wherein the period for the energy indicator value is one week, where, for a prediction model for a facilities managing system 1, one or more predicting variable candidates, from one day before to the time (day of the week) that is subject to the prediction through seven days before is/are identified as the predicting variable (variables) for a prediction model for the facilities managing system 1 for predicting the energy indicator value on that day of the week.

First the candidate profile creating portion 15A obtains a reference profile 14A from the storing portion 14 (Step 100), and rotates sequentially the correspondence relationship between the ranks and the intervals in the reference profile 14A to create respective candidate profiles 14B, for the different amounts of rotation, corresponding to the retrospection time that is the amount of rotation (Step 101).

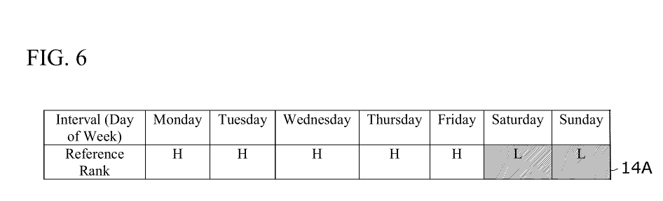

FIG. 6 is an example of a structure of a reference profile. Here an example is shown wherein the magnitudes of the energy indicator values in each of the intervals are ranked into two ranks, rank H and rank L. Specifically, Monday through Friday are ranked as rank H, and Saturday and Sunday are ranked as rank L.

For the reference profile 14A, the ranking may be performed in advance based on the equipment design or specifications and stored in the storing portion 14, or a reference profile creating portion may be provided in the calculation processing portion 15 and the reference profile 14A may be created based on time series data, indicating the energy indicator values obtained from the facilities managing system 1.

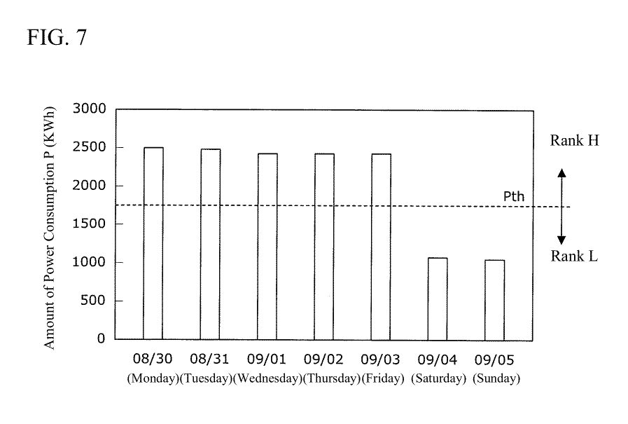

FIG. 7 is an explanatory diagram illustrating the method for creating a reference profile. A representative value is calculated for each interval from the time series data for the energy indicator values obtained from the facilities managing system 1. In this case, an energy indicator value for the specified period (one week), selected arbitrarily by the operator may be used as-is as the representative value.

Following this, the representative value for each interval may be compared to a threshold value Pth, and if greater than the threshold value Pth, then that segment may be ranked as rank H, and if the representative value is equal to or less than Pth, then that segment may be ranked as rank L. If a plurality of threshold values is set, then ranking may be performed into three or more ranks.

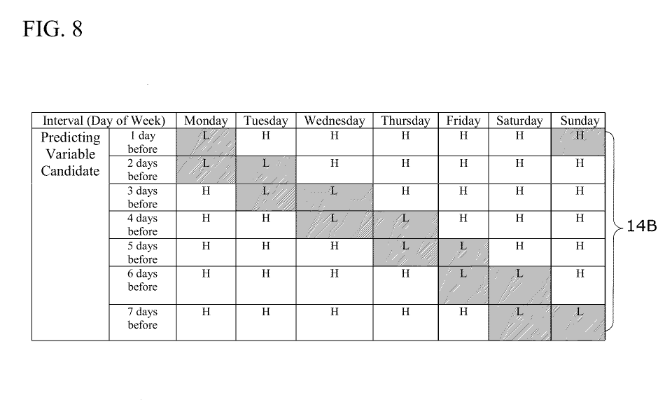

FIG. 8 is an example of creating a candidate profile. Here a reference profile 14B is created for each predicting variable candidate, from one day before through seven days before, for each different amount of rotation by rotating sequentially, one day at a time, the correspondence relationship between the intervals (days of the week) and the ranks (reference ranks) in the reference profile 14A. For example, for the predicting variable candidate “one day before,” the ranks (reference ranks) in the reference profile 14A have been rotated back by one day worth, where Tuesday through Saturday are ranked as rank H, and Sunday and Monday are ranked as rank L. This rotation indicates a procedure for rotating the ranks in a sequence wherein the first and last intervals in the period are connected together cyclically, where, in the example in FIG. 8, the rank is rotated from Sunday to Monday.

Following this, the control group classifying portion 15B, based on settings from the outside, depending on the inherent operating statuses of the equipment that have been inputted through the communication I/F portion 11 or the operation inputting portion 12, for the various intervals, classify one interval, or a plurality of continuous intervals, into a single control group, to create the group classification result 14C (Step 102).

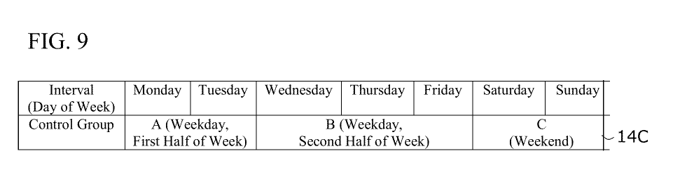

FIG. 9 is an example of control group classification. Here Monday and Tuesday are classified into a group A, indicating the first half of the week's weekdays, and Wednesday through Friday are classified into a group B, indicating the second half of the week's weekdays, where Saturday and Sunday are classified into a group C, indicating holidays.

Thereafter, the rank match checking portion 15C, based on the group classification results 14C, obtained from the control group classifying portion 15B, checks for whether or not the ranks match between the intervals that belong to the same control groups, for the correspondence relationships between the intervals and the ranks for the candidate profile 14B, for each candidate profile 14B created by the candidate profile creating portion 15A, and outputs the match check results 14D thus obtained (Step 103).

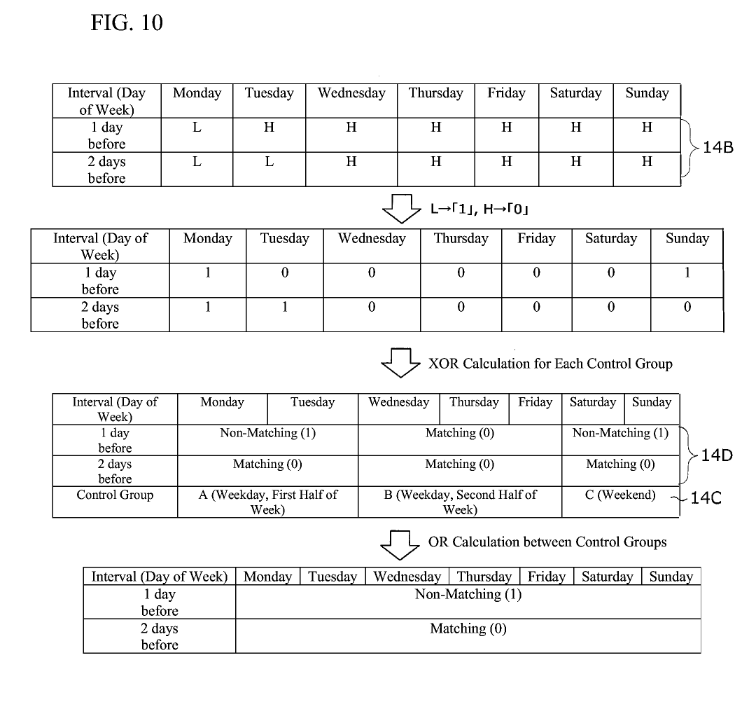

FIG. 10 is an explanatory diagram illustrating a rank match checking procedure. Here an example is shown wherein rank match checking is performed based on the group classification results 14C, illustrated in FIG. 9, for the prediction variable candidates “one day before” and “two days before” from the candidate profiles 14B illustrated in FIG. 8.

Here, for each candidate profile 14B, the rank L is replaced with a “1” and the rank H is replaced with a “0”, after which an exclusive logical sum (XOR) is calculated for each control group, and outputted as the match check result 14D.

For example, for the predicting variable candidate “one day before,” the individual ranks for Monday through Sunday will be replaced by “1, 0, 0, 0, 0, 0, 1”, and thus the XOR of the control groups A through C will be “1 (not matching), 0 (matching), 1 (not matching).” Moreover, for the predicting variable candidate “two days before,” the individual ranks for Monday through Sunday will be replaced by “1, 1, 0, 0, 0, 0, 0”, and thus the XOR of the control groups A through C will be “0 (matching), 0 (matching), 0 (matching).”

Thereafter, the predicting variable identifying portion 15D checks, for each candidate profile 14B, whether or not matches have been confirmed for the ranks for all of the control groups, based on the match check results 14D obtained from the rank match checking portion 15C (Step 104). Consequently, for each of the individual candidate profiles 14B in the example in FIG. 10, it is possible to check whether or not matches have been confirmed for the ranks for all of the control groups by calculating the logical sum (OR) between the control groups, where the OR for the predicting variable candidate “one day before” will be “1 (not matching)” and the OR for the predicting variable candidate “two days before” will be “0 (matching).”

If, at this point, matches have not been confirmed for the ranks for all of the control groups (Step 104: NO), then the series of processes is terminated. Consequently, in the example in FIG. 10, the predicting variable candidate “one day before” is not identified as a predicting variable.

On the other hand, if it is confirmed that the ranks match for all of the control groups (Step 104: YES), then the predicting variable identifying portion 15D identifies, as a predicting variable, the predicting variable candidate of the candidate profile 14B, and identifies, as a predicting variable to be used in the prediction model, a variable indicating the energy indicator value in an interval going back by the retrospection time corresponding to the candidate profile 14B from the point in time that is subject to the prediction (Step 105), and displays a screen of the prediction variable identification result 14E on the screen displaying portion 13 or outputs it from the communication I/F portion 11 to the facilities managing system 1 (Step 106), to complete the series of procedures.

Consequently, in the example in FIG. 10, the predicting variable candidate “two days before” is identified as a predicting variable. Note that the predicting variable identification result 14E should be data able to identify the predicting variable, such as text indicating a predicting variable name, a predicting variable ID, a retrospection time, or the like.

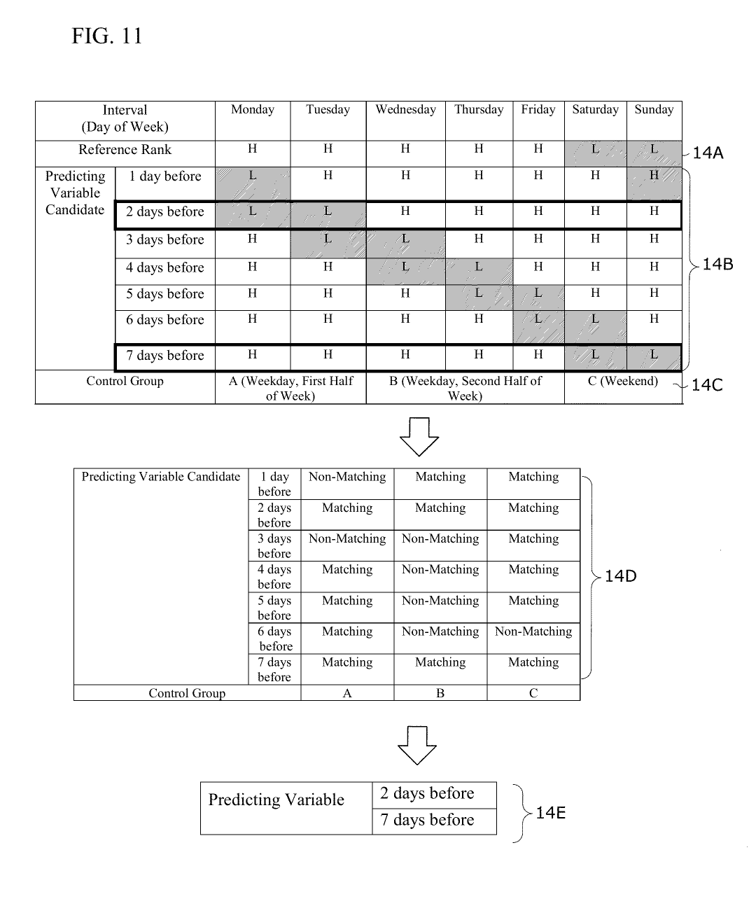

FIG. 11 is specific examples of predicting variables. Here an example will be presented wherein the predicting variable identifying procedure is performed based on the reference profile 14A of FIG. 6, the candidate profiles 14B created for the individual predicting variable candidates in FIG. 8, and the group classification results 14C of FIG. 9.

In this example, for the individual control groups A through C, the predicting variable candidates “one day before,” and “three days before” through “six days before” were non-matches, and the predicting variable candidates “two days before” and “seven days before” were matches. Consequently, the predicting variable candidates “two days before” and “seven days before” were identified as predicting variables, and were outputted as the predicting variable identification results 14E.

In this way, in the present example, the candidate profile creating portion 15A sequentially rotates the correspondence relationships between the intervals in the reference profile 14A and the ranks, to create respective candidate profiles 14B, for each different amount of rotation, corresponding to the retrospection times that are the applicable amounts of rotation. The group classifying portion 15B, based on a setting from the outside, performs classification of one interval or a plurality of continuous intervals into individual control groups. The rank match checking portion 15C, checks, for each candidate profile B, whether or not the ranks match across the intervals that belong to identical control groups, for the correspondence relationships between the intervals and the ranks in the candidate profiles 14B. The predicting variable identifying portion 15D identifies, as predicting variables to be used in the prediction model, those variables that indicate the energy indicator values in the intervals going back by the retrospection times corresponding to the applicable candidate profiles, from the point in time for which the prediction is to be made, for those candidate profiles 14B wherein the ranks have been confirmed to be matching for all of the control groups.

This enables the identification, as predicting variables in a prediction model, of variables able to explain both changes in an energy indicator value over individual intervals that structure a period, and the operating conditions that are inherent to the facility. Consequently, even if an operator does not have the expert knowledge required to construct a model, still predicting variables for the prediction model can be identified extremely easily. Moreover, the data required for reflecting the predicting emissions that are inherent to a facility need only be a reference profile and the result of control group classification. Because of this, the labor and time for the operation are trivial, making it possible to identify the predicting variables at an extremely low cost, making possible to provide remote management services inexpensively as well.

Furthermore, in the present example, when checking the rank matching for each of the control groups by the rank match checking portion 15C, and, further, when checking the rank matching between the control groups by the predicting variable identifying portion 15D, the ranks L and the H are converted into “1s” and “0s” and the rank matching check is performed through logic calculations, thus making it possible to check the rank matching through an extremely simple calculating procedure. Note that the procedure for checking the rank matching is not limited thereto, but the checking may be through a different procedural method instead.

Furthermore, while in the present example the explanation used an example of a case wherein a reference profile 14A was established in the storing portion 14 in advance, there is no limitation thereto. For example, the ranking for the individual intervals may be performed instead through calculating a representative value for each interval, from time series data for the energy indicator values obtained from the facilities managing system 1, as explained in FIG. 7, above, and comparing the representative values for the individual intervals to threshold values Pth. This is able to reduce the operational overhead through enabling the creation of the reference profile 14A automatically as part of the predicting variable identifying procedure, as long as there is time series data for the energy indicator values.

### Expanded Examples

While the present invention was explained above in reference to examples, the present invention is not limited by the examples set forth above. The structures and details of the present invention may be modified in a variety of ways, as can be understood by those skilled in the art, within the scope of the present invention.

While in the description set forth above the predicting variable identifying device 10 according to the present invention was explained using, as an example, a case wherein it was provided as an independent device outside of the facilities managing system 1, there is no limitation thereto, but rather the predicting variable identifying device 10 may be provided as one server that structures the facilities managing system 1, or the various functional portions of the predicting variable identifying device 10 may be embodied within an existing server for structuring the facilities managing system 1.

1. A predicting variable identifying device for identifying, as a predicting variable for a prediction model that predicts an energy indicator value at a point in time that is subject to prediction, a variable indicating the energy indicator value at an interval that goes back an arbitrary retrospection time from the point in time that is subject to the prediction, from among the individual intervals that structure a period, based on periodicity of the energy indicator values that indicate the energy consumption in the facilities, the predicting variable identifying device comprising:
a storing portion that stores a reference profile indicating a correspondence relationship between the individual intervals and ranks to which the magnitudes of the energy indicator values in the respective intervals belong;
a candidate profile creating portion that sequentially rotates the correspondence relationship between the intervals and ranks in the reference profile to create, for each different amount of rotation, a respective candidate profile corresponding to the retrospection time that is the applicable amount of rotation;
a control group classifying portion that classifies one interval or a plurality of continuous intervals into one control group, for each individual interval, based on a setting from the outside;
a rank match checking portion that checks, for each candidate profile, whether or not the ranks match between intervals belonging to the same control groups, for the correspondence relationships between the intervals and ranks in the applicable candidate profile; and
a predicting variable identifying portion that identifies, as a predicting variable for use in the prediction model, a variable that indicates the energy indicator value in the interval going back by the retrospection time corresponding to the candidate profile, from the point in time that is subject to prediction, for a candidate profile wherein the ranks have been confirmed as matching for all of the control groups.

2. A predicting variable identifying method used by a predicting variable identifying device for identifying, as a predicting variable for a prediction model that predicts an energy indicator value at a point in time that is subject to prediction, a variable indicating the energy indicator value at an interval that goes back an arbitrary retrospection time from the point in time that is subject to the prediction, from among the individual intervals that structure a period, based on periodicity of the energy indicator values that indicate the energy consumption in the facilities, the predicting variable identifying method comprising:
a storing step of storing at a storing portion a reference profile indicating a correspondence relationship between the individual intervals and ranks to which the magnitudes of the energy indicator values in the respective intervals belong;
a candidate profile creating step of sequentially rotating by a candidate profile creating portion the correspondence relationship between the intervals and ranks in the reference profile to create, for each different amount of rotation, a respective candidate profile corresponding to the retrospection time that is the applicable amount of rotation;
a control group classifying step of classifying by a control group classifying portion one interval or a plurality of continuous intervals into one control group, for each individual interval, based on a setting from the outside;
a rank match checking step of checking by a rank match checking portion, for each candidate profile, whether or not the ranks match between intervals belonging to the same control groups, for the correspondence relationships between the intervals and ranks in the applicable candidate profile; and
a predicting variable identifying step of identifying by a predicting variable identifying portion, as a predicting variable for use in the prediction model, a variable that indicates the energy indicator value in the interval going back by the retrospection time corresponding to the candidate profile, from the point in time that is subject to prediction, for a candidate profile wherein the ranks have been confirmed as matching for all of the control groups.

3. A computer-readable medium embodying a program for causing a computer to function as each of portions that structure a predicting variable identifying device for identifying, as a predicting variable for a prediction model that predicts an energy indicator value at a point in time that is subject to prediction, a variable indicating the energy indicator value at an interval that goes back an arbitrary retrospection time from the point in time that is subject to the prediction, from among the individual intervals that structure a period, based on periodicity of the energy indicator values that indicate the energy consumption in the facilities, the portions of the predicting variable identifying device comprising:
a storing portion that stores a reference profile indicating a correspondence relationship between the individual intervals and ranks to which the magnitudes of the energy indicator values in the respective intervals belong;
a candidate profile creating portion that sequentially rotates the correspondence relationship between the intervals and ranks in the reference profile to create, for each different amount of rotation, a respective candidate profile corresponding to the retrospection time that is the applicable amount of rotation;
a control group classifying portion that classifies one interval or a plurality of continuous intervals into one control group, for each individual interval, based on a setting from the outside;
a rank match checking portion that checks, for each candidate profile, whether or not the ranks match between intervals belonging to the same control groups, for the correspondence relationships between the intervals and ranks in the applicable candidate profile; and
a predicting variable identifying portion that identifies, as a predicting variable for use in the prediction model, a variable that indicates the energy indicator value in the interval going back by the retrospection time corresponding to the candidate profile, from the point in time that is subject to prediction, for a candidate profile wherein the ranks have been confirmed as matching for all of the control groups.
